(19) United States
(12) Patent Application Publication
(10) Pub. No.: US 2013/0047758 A1
(43) Pub. Date: Feb. 28, 2013

(54) Z-AXIS STAGE DRIVING APPARATUS, STAGE DRIVING APPARATUS, AND METHOD FOR MANIPULATING STAGE DRIVING APPARATUS

(71) Applicants: Ul Tae KIM, Suwon-si (KR); Hi Kuk Lee, Yongin-si (KR); Sang Don Jang, Suwon-si (KR); In Bae Jang, Seoul (KR); Jong Jin Lee, Seoul (KR)

(72) Inventors: Ul Tae KIM, Suwon-si (KR); Hi Kuk Lee, Yongin-si (KR); Sang Don Jang, Suwon-si (KR); In Bae Jang, Seoul (KR); Jong Jin Lee, Seoul (KR)

(73) Assignee: SAMSUNG ELECTRONICS CO., LTD., Suwon-si (KR)

(21) Appl. No.: 13/587,181

(22) Filed: Aug. 16, 2012

(30) Foreign Application Priority Data
Aug. 22, 2011 (KR) 10-2011-0083501

(51) Int. Cl. F16H 19/02; F16H 25/12

(52) U.S. Cl. 74/89.23; 74/89; 74/89.14

(57) ABSTRACT

Disclosed is Z-axis stage driving apparatus to move a stage on which a workpiece such as a wafer is placed along a Z-axis. The Z-axis stage driving apparatus includes a motor, a plurality of elevating devices to move a stage along a Z-axis, a power transmission device to transmit power of the motor to the plurality of elevating devices, and a clutch to control power transmission between the power transmission device and the elevating devices.

### CROSS-REFERENCE TO RELATED APPLICATION

This application claims priority from and the benefit of Korean Patent Application No. 10-2011-0083501, filed on Aug. 22, 2011, which is incorporated herein by reference for all purposes as if fully set forth herein.

### BACKGROUND OF THE INVENTION

1. Field of the Invention

Exemplary embodiments of the present invention relate to a Z-axis stage driving apparatus to move a stage on which a workpiece such as a wafer is placed along a Z-axis. Exemplary embodiments of the present invention also relate to a stage driving apparatus and method for manipulating the same.

2. Discussion of the Background

A stage is often used to assist performing certain semiconductor manufacturing processes, such as etching, deposition, exposure, etc., while a workpiece, such as a wafer, is placed on the stage. If necessary, a driving apparatus may be used to move the stage along a Z-axis in order to stabilize the stage horizontally and appropriately adjust the height of the workpiece.

The Z-axis stage driving apparatus includes a plurality of elevating mechanisms installed at lower corners of the stage for Z-axis movement of the stage and each elevating mechanism is provided with a drive unit. If the stage is tilted due to, e.g., unexpected amount of load, the drive unit of the elevating mechanism is controlled to stabilize the stage horizontally.

However, providing each elevating mechanism with a drive unit may make accurate control difficult due to difference in characteristics of the drive unit and due to multi-axis control. Since posture of the stage is detected and corrected in a feedback control manner, it may be hard to maintain the stage in a completely static state and to support great load of the stage along the Z-axis. Moreover, posture maintenance may require continuous supply of power, which causes heat emission, resulting in deterioration in the performance and accuracy of the entire system.

### SUMMARY OF THE INVENTION

Therefore, exemplary embodiments of the present invention provide a Z-axis stage driving apparatus, which enables precise height adjustment and maintenance of a stage.

Exemplary embodiments of the present invention provide a Z-axis stage driving apparatus, which exhibits less power consumption and heat emission.

Additional features of the invention will be set forth in part in the description which follows and, in part, will be obvious from the description, or may be learned by practice of the invention.

In accordance with an aspect of the present invention, a Z-axis stage driving apparatus includes a motor, a plurality of elevating devices to move a stage along a Z-axis, a power transmission device to transmit power of the motor to the plurality of elevating devices, and a clutch to control power transmission between the power transmission device and the elevating devices.

In accordance with another aspect of the present invention, a stage driving apparatus includes four elevating devices arranged beneath a stage to move the stage along a direction perpendicular to a surface of the stage, a motor, and a power transmission device to transmit power of the motor concurrently to the four elevating devices.

In accordance with still another aspect of the present invention, a method for manipulating a stage driving apparatus includes generating rotational power by a motor, and transmitting the rotational power from the motor by a power transmission device concurrently to a plurality of elevating devices arranged beneath a stage to move the stage along a direction perpendicular to the stage.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a perspective view illustrating a Z-axis stage driving apparatus according to an exemplary embodiment of the present invention.

FIG. 2 is a side view of the Z-axis stage driving apparatus illustrated in FIG. 1.

FIG. 3 is an enlarged view illustrating a coupling relationship between an elevating device and a second driven worm gear of FIG. 1.

FIG. 4 is a side view illustrating a Z-axis stage driving apparatus according to another exemplary embodiment of the present invention.

### DETAILED DESCRIPTION OF THE ILLUSTRATED EMBODIMENTS

The present invention will be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art.

In the drawings, the thickness of layers, films, panels, regions, etc., may be exaggerated for clarity. It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. In contrast, It will be understood that when an element such as a layer, film, region, or substrate is referred to as being “beneath” another element, it can be directly beneath the other element or intervening elements may also be present. Meanwhile, when an element is referred to as being “directly beneath” another element, there are no intervening elements present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Hereinafter, a Z-axis stage driving apparatus according to the exemplary embodiment will be described with reference to the drawings.

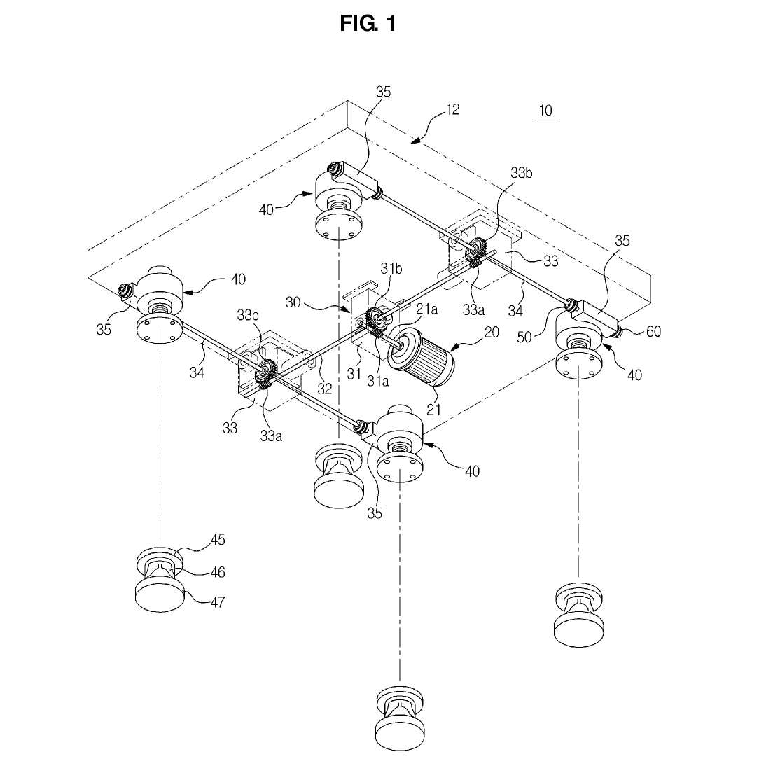

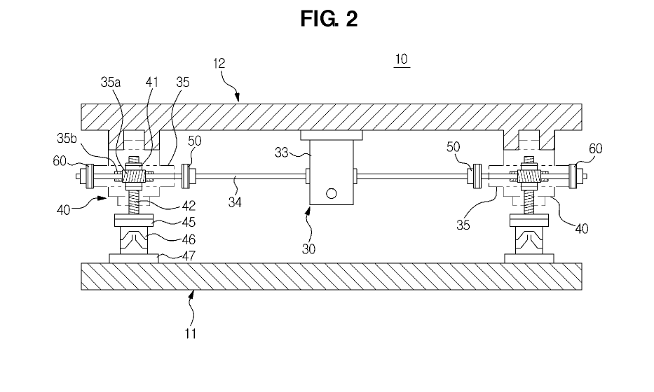

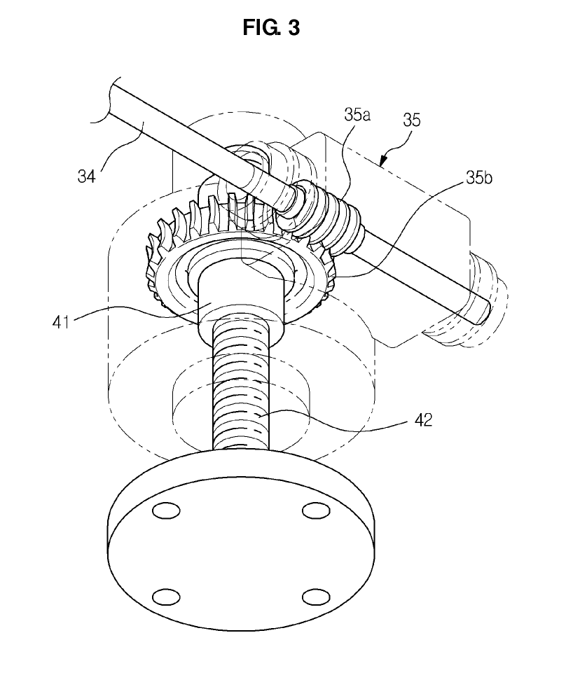

FIG. 1 is a perspective view illustrating a Z-axis stage driving apparatus according to an exemplary embodiment of the present invention, FIG. 2 is a side view of the Z-axis stage driving apparatus illustrated in FIG. 1, and FIG. 3 is an enlarged view illustrating a coupling relationship between an elevating device and a second driven worm gear of FIG. 1. As illustrated in FIG. 1, FIG. 2, and FIG. 3, the Z-axis stage driving apparatus 10 according to the exemplary embodiment includes a stage base 11 to support the apparatus 10, a stage 12 to move on the stage base 11, and a driving device 20 to enable Z-axis movement of the stage 12.

The Z-axis stage driving apparatus 10 includes a driving motor 21 to function as a power source, elevating devices 40 to induce Z-axis movement of the stage 12 upon receiving power from the driving motor 21, a power transmission device 30 to transmit power of the driving motor 21 to the respective elevating devices 40, clutches 50 to control power transmission between the elevating devices 40 and the power transmission device 30, and braking devices 60 to keep the elevating devices 40 stationary.

The driving motor 21 supplies power required to drive the elevating devices 40. The driving motor 21 may be a servo motor or stepping motor, to enable precise control by a controller (not shown).

The power transmission device 30 transmits power of the driving motor 21 to the respective elevating devices 40. For this, the power transmission device 30 includes a first driven shaft 32 to directly receive power from a driving shaft 21a of the driving motor 21, and a pair of second driven shafts 34, each of which receives power from the first driven shaft 32 and transmits the power to two corresponding ones of the four elevating devices 40, which will be described hereinafter.

A driving worm gear 31 is provided at a joint between the driving shaft 21a of the driving motor 21 and the first driven shaft 32 for power transmission. Thus, a worm screw 31a is connected to the driving shaft 21a of the driving motor 21, and a worm wheel 31b is connected to the first driven shaft 32. As illustrated, the power transmission device 30 may be located at the center of the four elevating devices 40 to ensure approximately the same power transmission distance to the respective elevating devices 40.

A first driven worm gear 33 is provided at a joint between the first driven shaft 32 and each of the second driven shafts 34. There are provided the pair of second driven shafts 34 such that each second driven shaft 34 is connected to the two elevating devices 40. Thus, the second driven shafts 34 are arranged at opposite ends of the first driven shaft 32 to extend perpendicular to the first driven shaft 32 while being spaced apart from each other.

The first driven worm gear 33 includes a worm screw 33a connected to either end of the first driven shaft 32 and a worm wheel 33b connected to the second driven shaft 34. Through the first driven worm gear 33, power of the first driven shaft 32 is transmitted to the second driven shaft 34, causing interlocking of the first driven shaft 32 and the second driven shaft 34.

To transmit power from the second driven shaft 34 to each elevating device 40, a second driven worm gear 35 is provided at a joint between either end of the second driven shaft 34 and the elevating device 40. The second driven worm gear 35 includes a worm screw 35a connected to the second driven shaft 34 and a worm wheel 35b connected to the elevating device 40, which will be described hereinafter, so as to engage with the worm screw 35a.

The driving motor 21 and the power transmission device 30 are installed below the stage 12 and thus, the driving motor 21 and the first driven worm gear 33 are secured to a lower surface of the stage 12.

There are four elevating devices 40 arranged respectively at four corners of the stage 12, to perform Z-axis movement and horizontal balancing of the stage 12 between the stage 12 and the stage base 11. The elevating devices 40 may include roller screws to convert rotational motion transmitted through the power transmission device 30 into rectilinear motion.

FIG. 3 is an enlarged view illustrating a coupling relationship between an elevating device and a second driven worm gear of FIG. 1. As illustrated in FIG. 3, the roller screw includes an input portion 41 to receive rotational motion, and an output portion 42 to perform rectilinear motion in response to the rotational motion of the input portion 41. The output portion 42 has threads formed at an outer surface thereof. The input portion 41 is rotatably fastened around the output portion 42 and in turn, the worm wheel 35b of the second driven worm gear 35 is fitted around the input portion 41, such that rotational power is transmitted from the second driven shaft 34 to the input portion 41.

A roller (not shown) is provided between the input portion 41 and the output portion 42. The roller screw corresponds to known technologies and description of a detailed configuration of the roller screw is thus omitted.

Since the roller screw operates like a ball screw, but more accurately operates and supports greater load, applying the roller screw to the elevating device 40 according to the exemplary embodiment enables precise Z-axis movement of the stage 12 and support of greater load.

Although the present exemplary embodiment illustrates the elevating device 40 as adopting the roller screw to convert rotational motion into rectilinear motion, this is given by way of example only and other mechanical elements to convert rotational motion into rectilinear motion in the same manner as the roller screw are applicable.

An upper end of the elevating device 40 is secured to the lower surface of the stage 12, and an intermediate plate 45 in the form of a flange is provided at a lower end of the elevating device 40.

A flexible coupler 46 and an air bearing pad 47 are provided below the intermediate plate 45. The flexible coupler 46 is a longitudinally deformable element. If the stage 12 is tilted during movement thereof due to difference in lengths of the elevating devices 40, the flexible coupler 46 absorbs strain, providing supporting force between the stage 12 and the stage base 11. In the present exemplary embodiment, the flexible coupler 46 takes the form of a hollow cylindrical member having curved incisions. However, the flexible coupler 46 is not limited to a hollow structure and is given by way of example only, and various other shapes are applicable so long as they provide flexibility in the longitudinal direction.

The air bearing pad 47 is floated by air on the stage base 11, having reduced friction to allow all devices on the stage base 11 to precisely move on the stage base 11.

The clutches 50 are provided at four locations on the second driven shafts 34 between the first driven worm gears 33 and the second driven worm gears 35, to control power transmission through the power transmission device 30 so as to enable independent operation of the four elevating devices 40.

The clutch 50 is an electronically-controlled clutch that is electronically controlled by a controller (not shown). Specifically, a non-excitation type electronically-controlled clutch may be used as the clutch 50 to reduce power consumption and heat emission.

The braking device 60 is installed to either end of the second driven shaft 34 extending from the worm screw 35a of the second driven worm gear 35 and located between the clutch 50 and the elevating device 40, such that the elevating device 40 is controlled in a desired manner and power transmission is switched off by the clutch 50 to keep the elevating device 40 stationary.

Similar to the clutch 50, the braking device 60 is an electronically-controlled brake that is electronically controlled by a controller (not shown). A non-excitation type electronically-controlled brake may be used as the braking device 60 to reduce power consumption and heat emission.

As described above, as a result of installing the clutch 50 and braking device 60 to enable individual power transmission from the single driving motor 21 to each of the four elevating devices 40 through the power transmission device 30 as well as individual operation of each elevating device 40 and of operating the braking device 60 in a released state of the clutch 50 while controlling power transmission time via the clutch 50, each elevating device 40 may be individually controlled, similar to the case of providing each elevating device 40 with the drive unit.

Accordingly, the single driving motor 21 may be used for Z-axis movement of the stage 12 and therefore, the entire driving device 10 may have a simplified configuration, having reduced power consumption and heat emission.

The height of each elevating device 40 may be accurately adjusted and maintained via the braking device 60.

Although the exemplary embodiment illustrates the four elevating devices 40 as being arranged in a rectangular shape at four corners of the lower surface of the stage 12 to support the stage 12, three elevating devices 40 may be arranged in a triangular shape to provide the stage 12 with 3-axis support. In this case, two elevating devices 40 may receive power through the second driven shafts 34 and the other elevating device 40 may be directly connected to the first driven shaft 32 without the second driven shaft 34.

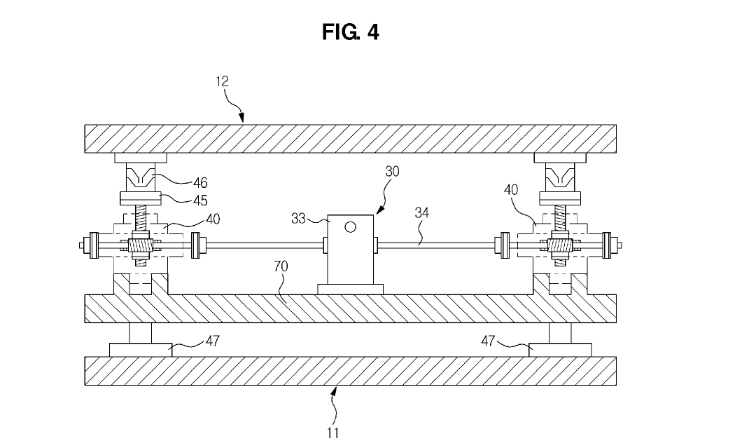

FIG. 4 is a side view illustrating a Z-axis stage driving apparatus according to another exemplary embodiment of the present invention. As illustrated in the drawing, a support plate 70 is additionally placed on the stage base 11 and the power transmission device 30 including a driving motor (not shown), and the first driven worm gear 33 is installed on an upper surface of the support plate 70. The support plate 70 is located between the power transmission device 30 and the stage base 11 and in turn, the air bearing pad 47 is installed between a lower surface of the support plate 70 and the stage base 11. Thus, all components including the power transmission device 30 on the stage base 11 may be driven while being floated by the air bearing pad 47. A flexible coupler 46 is installed between the elevating device 40 and the stage 12. If the stage 12 is tilted during movement, the flexible coupler 16 absorbs strain, providing supporting force between the stage 12 and the stage base 11.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. A Z-axis stage driving apparatus comprising:
a motor;
a plurality of elevating devices to move a stage along a Z-axis;
a power transmission device to transmit power of the motor to the plurality of elevating devices; and
a clutch to control power transmission between the power transmission device and the elevating devices.

2. The apparatus according to claim 1, further comprising a braking device to keep each of elevating devices stationary.

3. The apparatus according to claim 2, wherein the power transmission device comprises a first driven shaft to receive power from a driving shaft of the motor and at least one second driven shaft to receive power from the first driven shaft and transmit the power to at least one of the plurality of elevating devices.

4. The apparatus according to claim 3, wherein the power transmission device further comprises a driving worm gear connected between the driving shaft of the motor and the first driven shaft.

5. The apparatus according to claim 3, wherein the power transmission device further comprises a first driven worm gear connected between the first driven shaft and the at least one second driven shaft, and the at least one second driven shaft comprises a pair of second driven shafts.

6. The apparatus according to claim 1, wherein the power transmission device further comprises a second driven worm gear connected between each of the elevating devices and a second driven shaft.

7. The apparatus according to claim 6, wherein the clutch is installed on the second driven shaft between a first driven worm gear and the second driven worm gear, to independently control power transmission to each elevating device.

8. The apparatus according to claim 7, wherein the braking device is arranged between the elevating device and the clutch.

9. The apparatus according to claim 1, wherein the elevating device comprises a roller screw.

10. A stage driving apparatus comprising:
four elevating devices arranged beneath a stage to move the stage vertically;
a motor; and
a power transmission device to transmit power of the motor concurrently to the four elevating devices.

11. The apparatus according to claim 10, further comprising:
a clutch to control power transmission between the power transmission device and the respective elevating devices for independent driving of the respective elevating devices.

12. The apparatus according to claim 10, further comprising:
a braking device to keep the respective elevating devices stationary independently.

13. The apparatus according to claim 12, wherein the power transmission device comprises a first driven shaft to receive power from a driving shaft of the motor and at least one second driven shaft to receive power from the first driven shaft and transmit the power to at least one of the elevating devices.

14. The apparatus according to claim 13, wherein the power transmission device further comprises a driving worm gear connected between the driving shaft of the motor and the first driven shaft.

15. The apparatus according to claim 13, wherein the power transmission device further comprises a first driven worm gear connected between the first driven shaft and the at least one second driven shaft, and the at least one second driven shaft comprises a pair of second driven shafts.

16. The apparatus according to claim 12, wherein the power transmission device further comprises a second driven worm gear connected between each of the elevating devices and a second driven shaft.

17. The apparatus according to claim 12, wherein the power transmission device is located at the center of the four elevating devices.

18. A method for manipulating a stage driving apparatus, comprising:
generating rotational power by a motor; and
transmitting the rotational power from the motor by a power transmission device concurrently to a plurality of elevating devices arranged beneath a stage to move the stage along a direction perpendicular to the stage.

19. The method according to claim 18, further comprising:
controlling the transmission of the rotational power between the power transmission device and the respective elevating devices for independent driving of the respective elevating devices.
